(19) United States
(12) Patent Application Publication
(10) Pub. No.: US 2025/0202903 A1
(43) Pub. Date: Jun. 19, 2025

(54) METHOD FOR GENERATING IDENTITY AND ACCESS MANAGEMENT POLICY RECOMMENDATIONS

(71) Applicant: Also Known As, Inc., San Mateo, CA (US)

(72) Inventors: Robert Fry, Austin, TX (US); William Lin, SanFrancisco, CA (US); Scott Woods, Ipswich, MA (US)

(21) Appl. No.: 18/983,148

(22) Filed: Dec. 16, 2024

Related U.S. Application Data
(60) Provisional application No. 63/610,630, filed on Dec. 15, 2023.
(60) Provisional application No. 63/672,552, filed on Jul. 17, 2024.

(51) Int. Cl. H04L 9/40

(52) U.S. Cl. CPC H04L 63/105; H04L 63/102; H04L 63/108

(57) ABSTRACT

One variation of a method includes: accessing a first policy associated with a computer network; extracting a first entitlement from the first policy, the first entitlement granting permission to a first identity in the set of identities to access a first resource according to a first access level; accessing a first set of event data representing a first access attempt associated with the first resource by the first identity during a first time period, the first access attempt characterized by a second access level; detecting a deviation between the second access level and the first access level defined in the first entitlement; generating a second policy representing a second entitlement granting permission to the first identity to access the first resource according to the second access level in response to the deviation; and serving the second policy to an operator via an interface.

### CROSS-REFERENCE TO RELATED APPLICATIONS

This application claims the benefit of U.S. Provisional Application No. 63/610,630, filed on 15 Dec. 2023, and U.S. Provisional Application No. 63/672,552, filed on 17 Jul. 2024, each of which is incorporated in its entirety by this reference.

### TECHNICAL FIELD

This invention relates generally to the field of identity and access management and, more specifically, to a new and useful method for generating identity and access management policy recommendations within the field of identity and access management.

### BRIEF DESCRIPTION OF THE FIGURES

FIGS. 1A and 1B are flowchart representations of a method;

FIG. 2 is a flowchart representation of one variation of the method;

FIG. 3 is a flowchart representation of one variation of the method; and

FIG. 4 is a flowchart representation of one variation of the method.

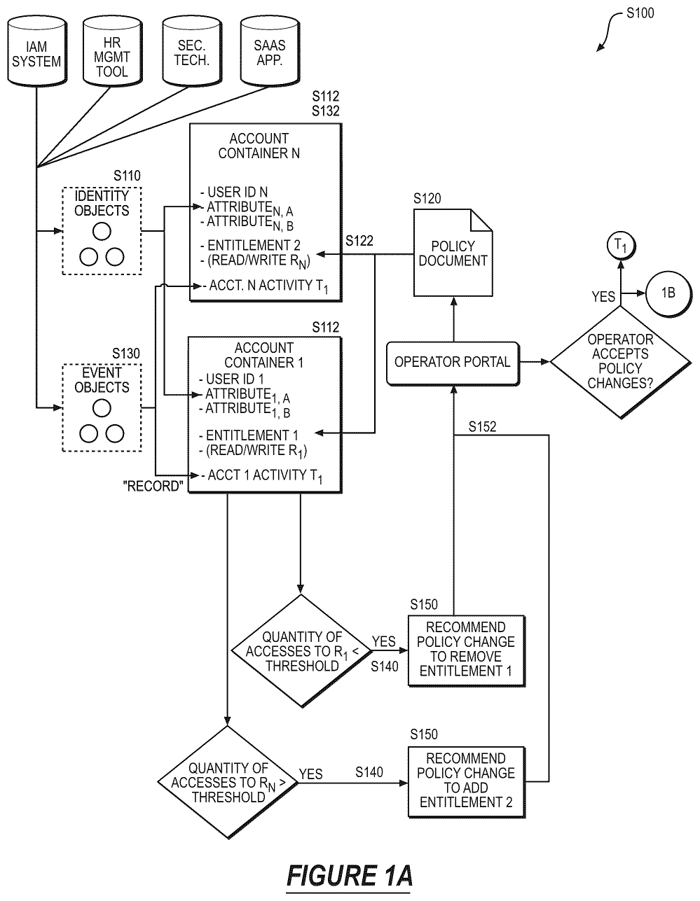

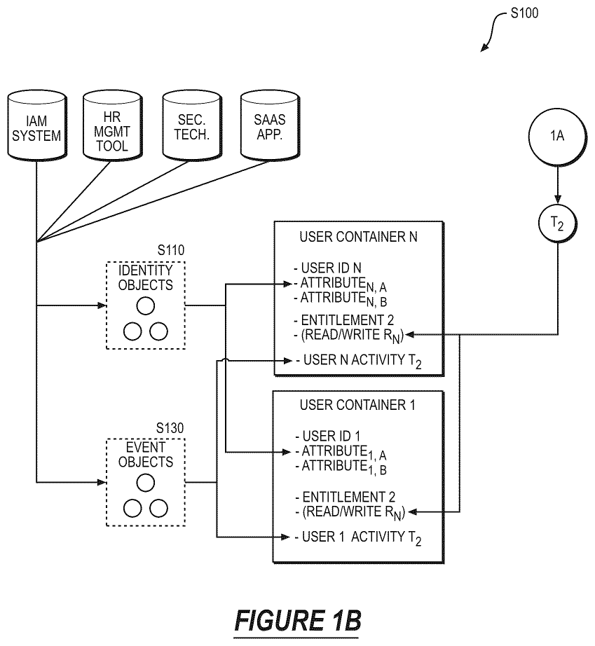

### DESCRIPTION OF THE EMBODIMENTS

The following description of embodiments of the invention is not intended to limit the invention to these embodiments but rather to enable a person skilled in the art to make and use this invention. Variations, configurations, implementations, example implementations, and examples described herein are optional and are not exclusive to the variations, configurations, implementations, example implementations, and examples they describe. The invention described herein can include any and all permutations of these variations, configurations, implementations, example implementations, and examples.

### 1. Methods

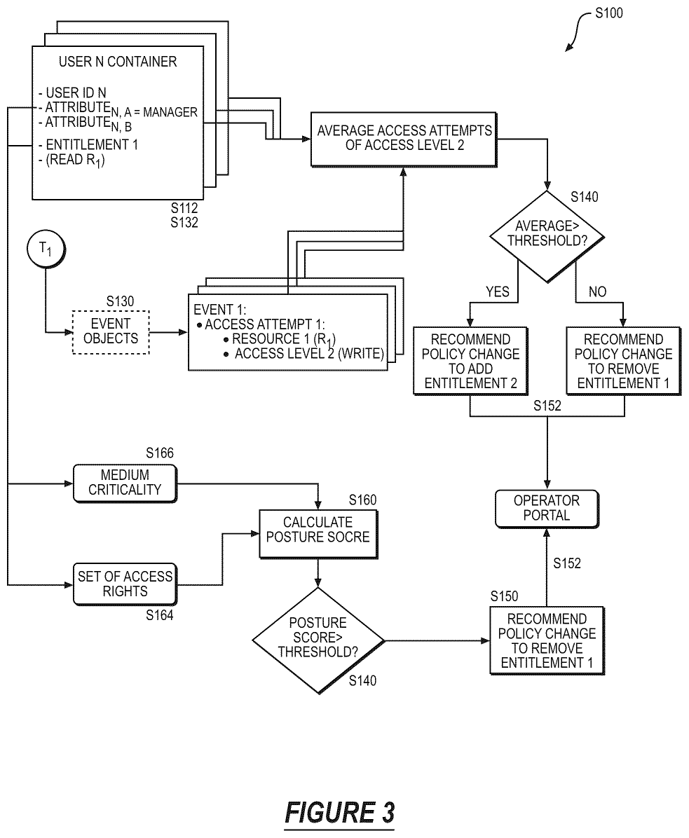

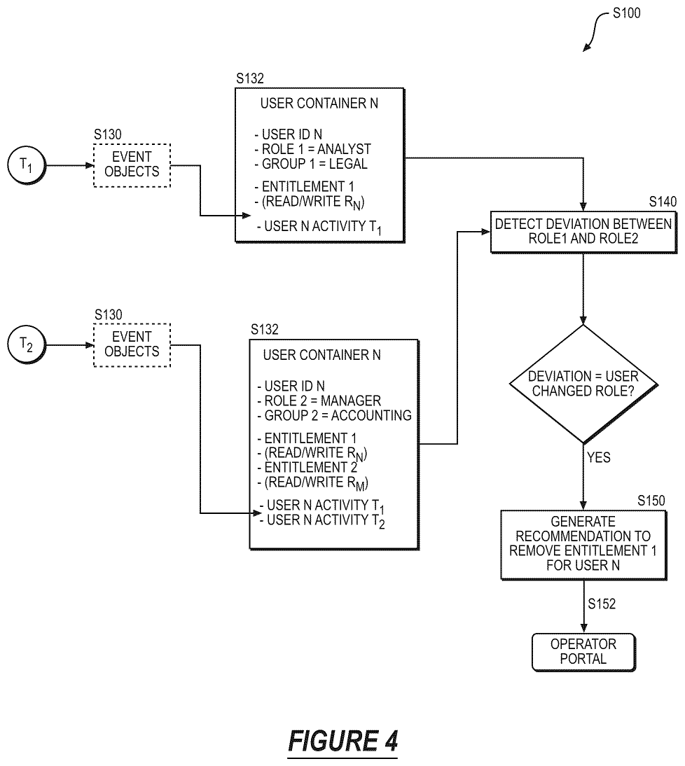

As shown in FIGS. 3 and 4, a method 100 includes: accessing a first set of objects generated by a source and representing a set of identities associated with a computer network in Block S110; detecting the set of identities based on the first set of objects in Block S112; accessing a first policy associated with the computer network in Block S120; extracting a first entitlement from the first policy, the first entitlement granting permission to a first identity in the set of identities to access a first resource, in a set of resources associated with the computer network, according to a first access level in Block S122; accessing a first set of event data representing activity associated with the set of resources during a first time period in Block S130; detecting a first access attempt associated with the first resource by the first identity based on the first set of event data, the first access attempt characterized by a second access level in Block S130; detecting a deviation between the second access level and the first access level defined in the first entitlement in Block S140; generating a second policy representing a second entitlement granting permission to the first identity to access the first resource according to the second access level in response to detecting the deviation in Block S150; and serving the second policy to an operator via an interface in Block S152.

### 1.1 Posture Score

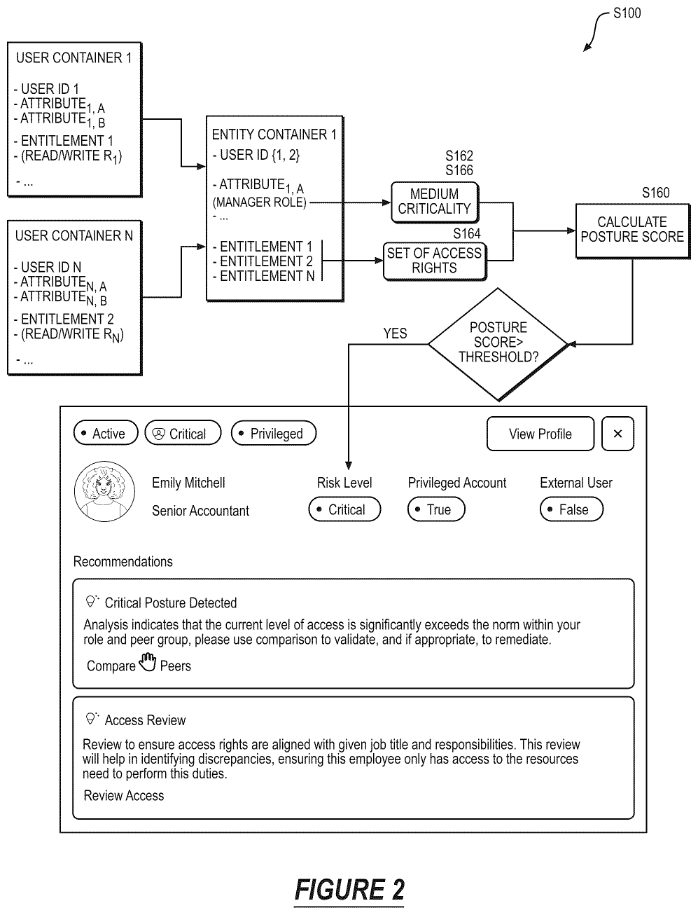

As shown in FIGS. 2 and 3, another variation of the method S100 includes: accessing a first set of objects generated by a source and representing a set of identities associated with a computer network in Block S110; detecting the set of identities based on the first set of objects in Block S112; accessing a first policy associated with the computer network in Block S120; extracting a first entitlement from the first policy, the first entitlement granting permission to a first identity in the set of identities to access a first resource, in a set of resources associated with the computer network, according to a first access level in Block S122; calculating a first posture score for the first identity based on the first access level and a first sensitivity level associated with the first resource in Block S160; in response the first posture score exceeding a threshold posture score, generating a second policy representing a second entitlement granting permission to the first identity to access the first resource according to a second access level falling below the first access level in Block S150; and serving the second policy to an operator via an interface in Block S152.

### 1.2 Access Reduction

As shown in FIG. 3, one variation of the method S100 includes: accessing a first set of objects generated by a source and representing a set of accounts associated with a computer network in Block S110; detecting the set of accounts based on the first set of objects in Block S112; accessing a first policy associated with the computer network in Block S120; extracting a first entitlement from the first policy, the first entitlement granting permission to a first account in the set of accounts to access a first resource, in a set of resources associated with the computer network, according to a first access level in Block S122; accessing a first set of event data representing activity associated with the set of resources during a first time period in Block S130; detecting a first access attempt associated with the first resource by the first account based on the first set of event data, the first access attempt characterized by a second access level falling below the first access level defined in the first entitlement in Block S130; in response to detecting the first access attempt characterized by the second access level exceeding the first access level, generating a second policy omitting the first entitlement and representing a second entitlement granting permission to the first account to access the first resource according to the second access level in Block S150; and serving the second policy to an operator via an interface in Block S152.

### 1.3 Variation: Access Frequency

As shown in the FIGURES, the method S100 includes: accessing a first set of objects, generated by a source during a target time interval, representing a set of identities in a computer network in Block S110; identifying the set of identities based on the first set of objects in Block S112; accessing a first policy defining a first entitlement granting permission, to a target identity, to access a first resource in a set of resources connected to the computer network in Block S120; detecting a first set of language signals in the first policy; accessing a model correlating language signals with entitlements and identities; based on the model, correlating the first set of language signals with a first identity in the set of identities; identifying the first identity as the target identity associated with the first entitlement; and associating the first entitlement with the first identity.

The method S100 also includes: accessing a first subset of objects, in a second set of objects generated by the source during the target time interval, representing a set of events associated with the set of resources, wherein each event in the set of events represents an action by the first user to a resource in the set of resources in Block S130; and storing the events into a first account profile representing activity of the first account during the target time interval in Block S132.

The method S100 further includes: accessing the first account profile specifying a first frequency of accesses to the first resource by the first account; identifying a first level of access to the first resource, exhibited by the first account, based on the first frequency of accesses; accessing the first entitlement assigned to the first account according to the first policy and defining a first level of permission to access the first resource in Block S122; detecting a first deviation between the first level of access to the first resource and the first level of permission to access the resource based on the first frequency of accesses falling below a first threshold quantity in Block S140; based on the first deviation, generating a second policy including a second entitlement, associated with the first account, defining a second level of permission falling below the first level of permission in Block S150; and serving the second policy to an operator via an operator portal in Block S152.

### 1.4 Posture and Access Reduction

As shown in the FIGURES, one variation of the method S100 includes: accessing a set of objects, generated by a set of sources during a target time interval, representing a set of identities in a computer network in Block S110; and identifying the set of identities based on the set of objects in Block S112.

This variation of the method S100 also includes, based on the set of objects, identifying a set of entitlements—granting permission to access resources in a set of resources to identities in the set of identities—associated with the set of identities, the set of entitlements including: a first subset of entitlements associated with a first identity in the set of identities; and a second subset of entitlements associated with a second identity in the set of identities, the first identity and the second identity corresponding to a first entity in a set of entities affiliated with the computer network in Block S122.

This variation of the method S100 further includes: based on the first subset of entitlements and the second subset of entitlements, identifying a first set of access rights assigned to the first entity, the first set of access rights associated with a first subset of resources in the set of resources in Block S164; assigning a first criticality level to the first entity based on a first role assigned to the first entity in Block S166; calculating a first posture score for the first entity based on the first set of access rights and the first criticality level in Block S160; in response to the first posture score exceeding a first threshold, selecting a first subset of access rights in the first set of access rights and associated with the first role; identifying a second subset of access rights in the first set of access rights and absent from the first subset of access rights; generating a notification recommending removal of the second subset of access rights from the first set of access rights in Block S150; and serving the notification to an operator via an operator interface in Block S152.

### 2. Applications

Generally, a computer system can execute Blocks of the method S100: to aggregate objects from various sources (e.g., identity and access management systems, security technologies, human resources management tools) during a target time interval; to identify a set of identities (e.g., accounts, roles, groups) within a computer network based on these objects; to ingest a policy document affiliated with the computer network; to extract a set of entitlements—representing permissions granted to identities to access resources connected to the computer network—from the policy document; and to automatically map each entitlement, in the set of entitlements, to identities in the set of identities in order to detect policy violations and/or control access to these resources.

The computer system can further execute Blocks of the method S100: to track activity—performed or initiated by each identity in the set of identities—executed on resources connected to the computer network during the target time interval, such as policy violations and/or (attempted) accesses to these resources; to detect deviations between this activity and entitlements mapped to identities; to generate recommended policy changes to respond to these deviations; and to serve these recommended policy changes to an operator via an operator terminal.

Accordingly, the computer system can execute Blocks of the method S100: to expose an entitlement—assigned to an identity within the computer network—that grants the identity a level of access to a resource exceeding (or falling below) a required (or nominal) level of access to the resource according to activity of the identity (e.g., via an account on the computer network); and to modify the set of policies to include new or refined entitlements that reflect this required level of access. Therefore, the computer system can execute Blocks of the method S100: to prevent over-provisioning and/or under-provisioning of (or to “right-size”) access to identities; to increase an overall security posture of the computer network; and to streamline access management workflows.

Additionally, the computer system can execute Blocks of the method S100: to prompt the operator (e.g., via the operator portal) for acceptance or rejection of a recommended policy change; to receive confirmation of acceptance or rejection of the recommended policy change from the operator; and to generate a rule, in a set of rules, based on this confirmation.

### 2.1 Access-Based Recommendations

Generally, the computer system can execute Blocks of the method S100: to extract an entitlement from a policy associated with a computer network, the entitlement granting a first access level to an identity, the first access level associated with a first resource; to access a set of event data representing interactions between the first identity and the first resource; to detect an access attempt, in the set of event data, characterized by a second access level different from (e.g., exceeding) the first access level; and, in response to the second access level exceeding the first access level, to generate a second policy defining a second entitlement granting the identity permission to access the first resource according to the second access level.

More specifically, the computer system can execute Blocks of the method S100 to: access a policy defining a set of entitlements; and extract an entitlement from the policy, the entitlement granting an access right (e.g., read) to an identity, the access right associated with (e.g., permissioned for) a resource on the computer network. Then, the computer system can: access event data representing interactions (e.g., activity) between the identity and the set of resources, such as access attempts characterized by access levels; identify a deviation between the access right granted by the entitlement and an access level (e.g., edit) associated with an access attempt on the resource by the identity; and, in response to the deviation representing the identity requesting to access the resource at a second (higher) access level than the access right permits, generate a second policy defining a second entitlement granting the identity the second access level.

Therefore, the computer system can recommend (or adjust) policies based on interactions (or event data) between an identity and resources on the computer network representing an “under-provisioning” of access rights for the identity.

### 2.2 Over-Provisioning

Additionally, the computer system can also identify an “over-provisioning” of access rights and, therefore, recommend (or adjust) policies to decrease access levels associated with access rights for a particular identity.

In one example, the computer system can: identify a first set of access rights for a first identity belonging to a first group (e.g., accounting) and associated with a first role (e.g., intern); identify a second set of access rights for a second identity belonging to the first group and associated with a second role (e.g., manager); identify a first subset of access rights in the first set of access rights absent from the second set of access rights; and, based on the second identity representing a manager of the first identity within the first group, generate a recommendation to remove the first subset of access rights from the first identity.

Therefore, the computer system decreases risk and increases security of the computer network by limiting access rights for each identity to access rights associated with a current role of the identity.

Additionally or alternatively, the computer system can: identify a first set of access rights granted to a first identity, the first set of access rights including a first access level (e.g., write access, edit access) associated with a first resource; access a first set of event data representing a first set of access attempts by the first identity on the first resource, the first set of access attempts characterized by a second access level (e.g., read-only access, view-only access); and, in response to the second access level falling below the first access level, generate a recommendation (e.g., a second policy) representing a second entitlement granting the first identity the second access level, and removing the first access level.

Accordingly, the computer system can identify “over-provisioning” of access rights to identities in the computer network by detecting absence of access attempts by the identity to a resource in the computer network. Therefore, by reducing access permissions to resources that an identity is not accessing, the computer system can: increase security of the computer network by reducing a total level of access for identities in the computer network; and decrease costs spent on resources not being accessed.

### 2.3 Posture

Additionally, the computer system can execute Blocks of the method S100: to identify a set of access rights granted to a first identity representing a first entity (e.g., an employee, an executive) affiliated with a computer network; to identify a criticality of the entity based on a role (e.g., a manager role, an executive role, an administrator role) assigned to the first entity; and to calculate a posture score for the first entity based on the set of access rights (e.g., a total amount of access to resources in the computer network) and the criticality level of the entity. The posture score characterizes risk (e.g., security risk, operational risk) posed to the computer network and attributed to the first entity.

In response to the posture score exceeding a threshold posture score, the computer system can further execute Blocks of the method S100: to identify a subset of access rights included in the set of access rights granted to the first identity and excluded from a target subset of access rights associated with entities assigned the first role; to generate a notification recommending removal of this subset of access rights from the set of access rights granted to the first identity; and to serve the notification to an operator.

Therefore, the system can execute Blocks of the method S100: to identify an entity posing relatively high risk to the computer network based on an amount of access granted to the identity and a criticality level assigned to the entity; and to recommend removal of access to certain resources from the entity in order to correct over-provisioning of (or “right-size”) access assigned to this entity, thereby reducing risk in the computer network.

### 3. Terminology

Generally, an “entity” is referred to herein as a discrete actor within a computer network.

Generally, an “identity” is referred to herein as a representation of an entity on the computer network.

Generally, a “user account” (or “account”) is referred to herein as an identity representing a unique entity.

Generally, a “group” is referred to herein as an identity representing a collection of accounts.

Generally, a “role” is referred to herein as an identity-representing a class of accounts-assignable to one or more accounts.

Generally, an “entitlement” is referred to herein as a permission-assigned to an identity-defining an action the identity may perform, data the identity may access, and/or a resource(s) the identity may control, etc.

Generally, a “criticality level” is referred to herein as an importance of an entity, an identity, etc. within an organization and/or the organization's computer network.

Generally, an “access level” (or an “access right”) is referred to herein as a particular right granted by an entitlement, to an identity, representing specific actions the identity may execute on resources on the organization's computer network, such as read, write, execute, etc.

### 4. Computer Network and Sources

Generally, various entities (e.g., human individuals, computer processes, software applications) may exhibit identities as user accounts (hereinafter “accounts”) in an organization's computer network. Accounts may access resources within and/or connected to an organization's computer network, such as: compute resources (e.g., workstations, laptops, servers, printers, smartphones); network resources (e.g., modems, gateways, routers, access points, subnets); data resources (e.g., storage volumes, databases, files); etc.

Sources—such as identity and access management systems, security technologies, human resources management tools, software-as-a-service (or “SaaS”) applications, productivity tools, etc.—may be deployed on (and/or interface with) devices (e.g., compute resources, network resources) in the computer network, and the sources can generate data based on communication with these devices. For example, a source can generate objects representing attributes of resources connected to the computer network at a target time (or during a target time interval). Additionally or alternatively, a source can generate objects representing attributes of accounts—extant on the computer network and/or accessing resources connected to the computer network—at the target time (or during the target time interval).

### 5. Account Identification

The method S100 includes: accessing a first set of objects generated by a source and representing a set of identities associated with a computer network in Block S110; and detecting the set of identities based on the first set of objects in Block S112.

Generally, in Blocks S110 and S112, the computer system can access information defining a set of accounts detected by a source.

In one implementation, in Block S110, the computer system accesses a set of objects generated by a source during a target time interval. For each object in the set of objects, the computer system: extracts a set of attributes represented by the object; identifies an account associated with the set of attributes; accesses (or generates) an account container (or data container) corresponding to the account in Block S132; and stores the set of attributes into the account container.

Accordingly, the computer system can populate a set of account containers representing attributes of a set of accounts detected by a source, each account container representing attributes of one account—in the set of accounts—during the target time interval.

### 5.1 Object Aggregation

Generally, the computer system can access a set of objects generated by a source during a target time interval in Block S110.

In one implementation, the computer system receives a set of objects transmitted (or “pushed”) from the source. In this implementation, the computer system can periodically receive a set of objects pushed from the source at a predefined frequency (e.g., once per hour, once per day).

In another implementation, the computer system retrieves the set of objects from the source. For example, the computer system can request (or “poll”) the source for a first set of objects via a first application programming interface (or “API”) call. In this example, the computer system can receive the first set of objects from the source in response to the first API call.

In this implementation, the computer system can periodically poll the source for a set of objects at a predefined frequency (e.g., once per hour, once per day).

### 5.2 Attributes

In one implementation, the computer system extracts a set of attributes represented by an object. For example, the computer system can extract the set of attributes including: a unique identifier (e.g., a globally unique identifier) assigned by the source; a name (e.g., a first name, a last name, a nickname); a username; an employee number; an email address; a phone number; a role; a group; a job title; a position level; a user type; a location (e.g., an office location, a current location); an IP address; an activity status (e.g., active, inactive); a latest login date/time; a start date; a termination date; etc.

In another implementation, based on identifying data in the set of attributes, the computer system identifies an account—in a set of accounts affiliated with an organization—associated with the set of attributes. The computer system then: accesses an account container associated with the account; and stores the set of attributes into the account container in Block S132.

For example, the computer system can: extract a first set of attributes—represented in a first object generated by a first source—including a first globally unique identifier assigned by the first source to a first account; and identify the first set of attributes as corresponding to the first account based on the first globally unique identifier. In response to identifying the first set of attributes as corresponding to the first account, the computer system can: access (or generate) a first account container associated with the first account; and store the first set of attributes into the first account container.

The computer system can execute the foregoing methods and techniques for each object in the set of objects: to extract a set of attributes represented in the object; to identify an account—in the set of accounts—associated with the set of attributes; to access an account container, in a set of accounts containers, associated with the set of attributes; and to store the set of attributes into the account container.

### 5.2.1 Normalization

In one implementation, the computer system executes Block S132 to store a set of attributes—represented by an object generated by a first source—into the account container by: accessing a first schema defining a first format and/or a first lexicon for attributes represented in objects generated by the first source; interpreting the set of attributes based on the first schema; and compiling the set of attributes into the account container according to a second schema defining a second format and/or a second lexicon. More specifically, the computer system can: normalize a first attribute, in the set of attributes, according to the second schema as a first normalized attribute; and store the first normalized attribute in the account container.

In one variation, the computer system: stores the set of attributes into a first account container associated with a first account; normalizes the set of attributes according to the second schema as a normalized set of attributes; and stores the normalized set of attributes in a second account container associated with the first account. In this variation, the computer system can: generate an association between the first account container and the second account container; and store the association in the first account container and/or the second account container.

### 6. Roles and Groups

Generally, the computer system can access information defining a set of roles and a set of groups detected by a source in Block S162.

In one implementation, the computer system executes similar methods and techniques: to access an object—generated by a source—representing a set of attributes of a role in a set of roles; to extract the set of attributes from the object; to access (or generate) a role container associated with the role; and to store the set of attributes into the role container. For example, the computer system can store—into the role container—the set of attributes including: a role name; a role description; a maximum duration the role may be assigned to an identity; etc.

In another implementation, the computer system executes similar methods and techniques: to access an object—generated by a source—representing a set of attributes of a group in a set of groups; to extract the set of attributes from the object; to access (or generate) a group container associated with the group; and to store the set of attributes into the group container. For example, the computer system can store—into the group container—the set of attributes including: a group name; a group description; a set of accounts included in the group; etc.

### 7. Additional Sources

Generally, for each source in a set of sources, the computer system can execute the foregoing methods and techniques to access information defining a set of accounts, a set of roles, and a set of groups detected by the source.

More specifically, the computer system can execute the foregoing methods and techniques for each source in a set of sources: to access a set of objects generated by the source; to extract attributes represented by objects in the set of objects; to identify accounts, in a set of accounts detected by the source, associated with these attributes; to access (or generate) a set of account containers associated with the set of accounts; and to store attributes into account containers in the set of account containers.

### 7.1 Entity Correlation

Generally, the computer system can: correlate an account container (and attributes stored within the account container) with an entity in a set of entities affiliated with an organization; access (or generate) an entity container associated with the entity; generate an association between the account container and the entity container; and store the association in the entity container and/or the account container in Block S132.

In one implementation, the computer system: accesses a first account container storing a first set of attributes, of a first account, detected by a first source; correlates the first account to a first entity in the set of entities affiliated with the organization based on identifying data (e.g., an employee identifier, an email address) in the first set of attributes; generates a first entity container associated with the first entity; generates a first association between the first entity container and the first account container; and stores the first association in the first entity container.

In another implementation, the computer system: accesses a second account container storing a second set of attributes, of a second account, detected by a second source; and correlates the second account to the first entity in the set of entities affiliated with the organization based on identifying data in the second set of attributes. For example, the computer system can identify a second email address, in the second set of attributes, as corresponding to (e.g., identical to) a first email address in the first set of attributes, the first email address and the second email address associated with the first entity.

In this implementation, the computer system can: access the first entity container associated with the first entity; generate a second association between the first entity container and the second account container; and store the second association in the first entity container.

Additionally, the computer system can: generate a first unique identifier (e.g., universally unique identifier) associated with the first entity; and store the first unique identifier in the first entity container.

The computer system can execute the foregoing methods and techniques for each account container in the set of account containers.

Therefore, the computer system can map a set of account identities—represented by sets of attributes stored in account containers—to a particular entity in the set of entities affiliated with the organization.

### 8. Policy Ingestion

The method S100 includes: accessing a first policy associated with the computer network in Block S120; and extracting a first entitlement from the first policy, the first entitlement granting permission to a first identity in the set of identities to access a first resource according to a first access level in Block S122.

Generally, in Blocks S120 and S122, the computer system can: access a policy defining an entitlement; identify an identity (e.g., an account, a role, a group) associated with the entitlement; and store the entitlement in a container (e.g., an account container, a role container, a group container) corresponding to the identity. More specifically, the computer system accesses (or ingests) a policy document affiliated with an organization and including a set of policies, each policy—in the set of policies—defining an entitlement(s) associated with a target identity in the organization's computer network.

In one implementation, the computer system can access the set of policies including an identity-based policy—associated with an individual identity (e.g., an account(s), a group(s), a role(s))—defining an action that is permitted to execute on a resource. For example, the computer system can access a first policy specifying that a first account is permitted to read and write data in a first folder.

In another implementation, the computer system can access the set of policies including a resource-based policy—associated with a resource—defining a set of identities granted permission to access the resource. For example, the computer system can access a second policy specifying that a first role is permitted to read data in a second data store.

In another implementation, the computer system can access the set of policies including a role-based policy—associated with a role—defining a set of permissions granted to identities (e.g., accounts, groups) assigned the role. For example, the computer system can access a third policy specifying assignment of a second role—exhibiting full access to resources—to an administrator group.

In another implementation, the computer system can access the set of policies including a permission boundary policy—associated with an identity—defining a limit (or range) of permissions granted to an identity. For example, the computer system can access a fourth policy specifying that a third role is permitted read-only access to a first subset of resources.

In one implementation, for each policy in the set of policies, the computer system: identifies an entitlement, defined by the policy, and an identity (or identities) associated with the entitlement; accesses a container associated with the identity; and stores the entitlement into the container. More specifically, the computer system can extract the first entitlement from the first policy by: detecting a first set of language signals in the first policy; accessing a model that correlates language signals with entitlements; and extracting the first entitlement based on the model and the first set of language signals in Block S122. In particular, the computer system can: parse a first policy (or the policy document); detect a first set of language signals in the first policy; access a model (e.g., a large-language model) correlating language signals with entitlements and/or identities; and, based on the model, correlate the first set of language signals with a first entitlement and a first identity associated with the first entitlement; identify the first identity as a target identity associated with the first entitlement; and associate the first entitlement with the first identity.

For example, the computer system can: parse the policy document; detect the first policy specifying that the first account is permitted to read and write data in the first folder; access a first account container associated with the first account; and store the first entitlement-representing permission to read and write data in the first folder-into the first account container.

Additionally or alternatively, the computer system can store the first entitlement into a data repository different from the first account container, such as an entitlement container.

Accordingly, the computer system can: parse a policy document including a set of policies; extract entitlements from the set of policies; and automatically map these entitlements to identities (e.g., to containers corresponding to these identities) within an organization's computer network. Therefore, the computer system can ensure that entitlements specified in the policy document are selectively associated with identities within the computer network in order to detect policy violations and/or control access to resources connected to the computer network.

### 9. Account Profiles

Generally, the computer system can access a set of event objects—generated by a source—representing activity (or “events”) associated with the set of resources connected to the computer network during a target time interval (e.g., one day, 30 days) in Block S130. For each event object in the set of event objects, the computer system can: detect an event represented by the event object; identify an account associated with the event; access (or generate) an account profile associated with the account; and store the event into the account profile.

In one implementation, the computer system generates a set of account profiles. In this implementation, the computer system generates an account profile: associated with an account in the set of accounts; and representing activity (or absence of activity) of the account during the target time interval (and/or across a set of time intervals). The computer system can store the account profile in an account container corresponding to an account associated with the account profile. Additionally or alternatively, the computer system can store the set of account profiles in a data repository different from the set of account containers.

In another implementation, the computer system: accesses a first event object in the set of event objects; and detects a first event—represented by the first event object—representing an access (e.g., a read access, an attempted write access) to a first resource by a first account in the set of accounts. In this implementation, the computer system: accesses a first account profile, in the set of account profiles, associated with the first account; and stores the first event into the first account profile.

For example, the computer system can: detect a first event—represented by the first event object—representing an attempted write access to a first folder by a first account identifier associated with the first account; and correlate the first event with the first account based on the first account identifier. Additionally, the computer system can detect a policy violation associated with the first event based on a first entitlement—assigned to the first account—specifying read-only access to the first folder by the first account. In this example, the computer system can: access the first account profile associated with the first account; and store, into the first account profile, the first event and an indication of the policy violation associated with the first event.

The computer system can repeat the foregoing methods and techniques for each event object in the set of event objects to populate a set of account profiles with events and/or policy violations detected during the target time interval.

Accordingly, for each account in the set of accounts, the computer system can: track activity—initiated or performed by the account—executed on resources connected to the computer network during the target time interval, such as (attempted) accesses to these resources and/or policy violations; and encapsulate this activity in a profile representing behavior characteristic of the account. Therefore, the computer system can then: access a set of entitlements-assigned to the account based on a set of policies-representing permitted activity by the account; detect deviations between the activity (e.g., accesses to resources, attempted accesses to resources, absence of activity) during the target time interval and the permitted activity represented by the set of entitlements; and generate recommendations to respond to these deviations, as described below.

Additionally, for each source in a set of sources, the computer system can execute the foregoing methods and techniques: to access information (e.g., event objects, access logs) representing activity associated with the set of resources connected to the computer network during a target time interval and detected by the source; and to correlate the activity with an account in the set of accounts.

### 9.1 Role and Group Profiles

In one implementation, the computer system executes similar methods and techniques to generate a set of role profiles. The computer system generates a role profile: associated with a role in the set of roles; and representing activity (or absence of activity) of accounts assigned the role during the target time interval (and/or across a set of time intervals). The computer system can store a role profile in a role container corresponding to a role associated with the role profile. Additionally or alternatively, the computer system can store the set of role profiles in a data repository different from the set of role containers.

In this implementation, in response to detecting a first event representing an access to a first resource by the first account and in response to identifying a first role assigned to the first account, the computer system: accesses a first role profile, in the set of role profiles, associated with the first role; and stores the first event into the first role profile.

Accordingly, by associating detected events—attributed to an account—with a particular role assigned to the account, the computer system can thereby: generate a profile representing behaviors characteristic of all accounts assigned the particular role; detect deviations between activity (e.g., accesses to resources, attempted accesses to resources, absence of activity) during the target time interval and permitted activity as defined by a set of entitlements assigned to the particular role; and generate recommendations based on these deviations, as described below.

Additionally, the computer system can execute similar methods and techniques: to generate a set of group profiles, each group profile associated with a group in the set of groups and representing activity (or absence of activity) of accounts assigned to the group during the target time interval (and/or across a set of time intervals); to detect an event representing an access to a resource by an account assigned to a particular group; and to store the event into a group profile associated with the particular group.

### 10. Policy Recommendations

Generally, in response to populating a profile (e.g., an account profile, a role profile, a group profile) with events representing activity by an account(s) associated with the profile during the target time interval (or across multiple time intervals), the computer system can: access a set of entitlements—assigned to the account based on a set of policies—representing permitted activity by the account in Block S122; detect a deviation between the activity by the account and the permitted activity represented by the set of entitlements in Block S140; generate a recommendation (e.g., a recommended policy) to respond to the deviation in Block S150; and serve the recommendation to an operator via an operator portal in Block S152.

Additionally, the computer system can: generate a notification specifying the deviation; and serve the notification to the operator via the operator portal. For example, the computer system can generate the notification specifying the deviation (e.g., a policy violation) and the recommendation (e.g., a recommended policy).

### 10.1 Permission Reduction

In one implementation, the computer system: accesses a set of event data specifying a first frequency of accesses to a first resource (e.g., a protected file) by a first account in Block S130; identifies a first level of access to the first resource, exhibited by the first account, based on the first frequency (and/or type) of accesses to the first resource in Block S130; accesses a first entitlement assigned to the first account according to a first policy and defining a first level of permission (e.g., read access, read and write access), to access the first resource, granted to the first account in Block S122; and, in response to the first frequency of accesses within a predefined duration (e.g., one month, three months) corresponding to (or falling below) a first threshold quantity (e.g., zero accesses, one access), detects a first deviation—representing an over-provisioning of permission to access the first resource—between the first level of access exhibited by the first account and the first level of permission granted to the first account in Block S140.

In this implementation, based on the first deviation representing the over-provisioning of permission to access the first resource, the computer system: generates a second policy (or “recommended policy”) including a second entitlement—associated with the first account—defining a second level of permission (e.g., no access) falling below the first level of permission; and serves the second policy to the operator via the operator portal.

Accordingly, by generating and serving the second policy including the second entitlement defining the second level of permission falling below the first level of permission and corresponding to the first level of access exhibited by the first account, the computer system can adjust permission—granted to the first account—to access the first resource based on historical accesses (or absence of access) to the first resource by the first account identified in the set of event data, thereby reducing risk of unauthorized access to the first resource (e.g., based on impersonation of the first account by a malicious actor) and increasing a security posture of the computer network.

In one variation, the computer system updates the first policy: excluding the first entitlement defining the first level of permission; and including the second entitlement defining the second level of permission. More specifically, the computer system can update the first policy to generate the second policy.

For example, the computer system can extract an entitlement from the first policy, the entitlement granting permission to the first identity to access a resource according to a first access level. The computer system can then: access a set of event data representing activity associated with the set of resources during a first time period; and detect absence of an event, representing an access attempt associated with the second resource by the first identity, in the first set of event data. Then, in response to absence of the event representing attempted access to the resource by the first identity, the computer system generates a second policy omitting the entitlement. Therefore, by identifying absence of access attempts by an identity to a resource on the computer network, the computer system can revoke the first access level (and/or revoke access rights) from the first identity.

In a similar example, the computer system can: extract a first entitlement from a first policy, the entitlement granting a first access level, to a resource, to the first identity; access a set of event data representing a first quantity of access attempts associated with the resource by the first identity; in response to the first quantity of access attempts falling below a threshold quantity, generate a second policy representing a second entitlement removing access for the first identity to the second resource; and serve the second policy to the operator via the interface.

Accordingly, in the foregoing examples, in response to detecting an absence of access attempts by the first identity to access a resource during a target time period, the computer system can generate a policy omitting (or removing) access rights for the first identity to access the resource.

In another example, the computer system detects a first resource (e.g., a first group communication application), in the set of resources and characterized by a first resource type (e.g., group communication application), on the computer network. During a first time period, the computer system accesses a first set of event data representing activity associated with the first resource, including a first set of access attempts by accounts on the computer network to the first resource.

Then, during a second time period succeeding the first time period, the computer system can detect a second resource (e.g., a second group communication application) in the set of resources and characterized by the first resource type. In response to detecting the second resource, the computer system can access a second set of event data representing activity associated with the second resource, such as including a second set of access attempts by accounts on the computer network to the second resource; and access a third set of event data representing activity associated with the first resource, such as including a third set of access attempts by accounts on the computer network to the first resource during the second time period.

Then, in response to the second set of access attempts exceeding a first threshold quantity of access attempts to the second resource and in response to the third set of access attempts falling below a second threshold quantity of access attempts to the first resource, the computer system can generate a recommendation to remove the first resource from the computer network.

Additionally or alternatively, in this example, the third set of access attempts to the first resource can represent absence of access attempts to the first resource.

Accordingly, in the foregoing example, the computer system can detect a first resource of a first resource type, and a second resource of the first resource type. Then, the computer system can access a first set (or quantity) of access attempts to the first resource, and a second set (or quantity) of access attempts to the second resource. In response to the first quantity of access attempts (or absence of access attempts) to the first resource falling below the second quantity of access attempts to the second resource, the computer system can identity a first transition to the second resource, such as the second resource replacing the first resource.

Therefore, the computer system can detect absence of attempted access to a resource by an identity in the computer network in order to identify “over-provisioning” of access rights granted to the identity to access the resource. Thus, the computer system can reduce (or revoke) these access rights granted to the identity in order to reduce risk of unauthorized access to the resource and/or to reduce costs (e.g., resource license costs) associated with access to the resource.

### 10.1.1 Feedback

In another implementation, the computer system can prompt the operator—via the operator portal—to accept the second policy.

In this implementation, in response to the operator accepting the second policy, the computer system can store a first record indicating acceptance of the second policy. More specifically, the computer system can store the first record indicating acceptance of the second policy defining the second level of permission—falling below the first level of permission—in response to absence of access to the first resource by the first account within the predefined duration.

Accordingly, based on the first record, the computer system can generate a first rule to reduce a level of permission—granted to an account—to access the first resource (or another resource) in response to detecting absence of access to the first resource by the account within the predefined duration. Therefore, the computer system can repeat the foregoing methods and techniques: to detect deviations representing over-provisioning of permission—to access the first resource (or other resources)—to other accounts in the set of accounts based on absence of access to the first resource by these accounts within the predefined duration; based on the first rule and these deviations, to generate a recommended policy (or policies) including entitlements defining a subsequent level of permission (e.g., no access) falling below an initial level of permission granted to these accounts (e.g., read access, read and write access); and to serve the recommended policy to the operator via the operator portal.

Alternatively, in response to the operator rejecting the second policy, the computer system can store the first record indicating rejection of the second policy. Based on the first record indicating rejection of the second policy, the computer system can: generate a second rule to omit reduction of a level of permission—granted to an account—to access the first resource (or another resource) in response to detecting absence of access to the first resource by the account within the predefined duration.

### 10.1.2 Automated Policy Changes

In another implementation, in response to accepting the second policy, the operator may (manually) implement the second policy in the computer network.

In one variation, in response to the operator accepting the second policy, the computer system automatically implements the second policy in the computer network. More specifically, the computer system can execute the foregoing methods and techniques: to identify an entitlement defined by the second policy; to identify an identity associated with the entitlement; to access a container associated with the identity; and to store the entitlement into the container.

### 10.2 Permission Expansion

In one implementation, the computer system: accesses a second account profile specifying a second frequency of (policy violations or) attempted accesses to a second resource (e.g., a CAD application) by a second account; identifies a second level of access to the second resource, exhibited by the second account, based on the second frequency (and/or type) of attempted accesses to the second resource; accesses a third entitlement assigned to the second account according to a third policy and defining a third level of permission (e.g., no access), to access the second resource, granted to the second account; and, in response to the second frequency of attempted accesses within a predefined duration (e.g., one month, three months) exceeding a second threshold quantity (e.g., zero attempted accesses, five attempted accesses), detects a second deviation-representing an under-provisioning of permission to access the second resource-between the second level of access exhibited by the second account and the second level of permission granted to the second account.

In this implementation, based on the second deviation representing the under-provisioning of permission to access the second resource, the computer system: generates a fourth policy (or “recommended policy”) including a fourth entitlement—associated with the second account—defining a fourth level of permission (e.g., full access) exceeding the third level of permission and corresponding to the second level of access exhibited by the second account; and serves the fourth policy to the operator via the operator portal.

Additionally, the computer system can execute the foregoing methods and techniques: to prompt the operator—via the operator portal—to accept the fourth policy; and to automatically implement the fourth policy in the computer network in response to the operator accepting the fourth policy.

### 10.2.1 Group and Role Permission Expansion

In another implementation, the computer system accesses a first set of event data specifying a frequency of attempted accesses to the resource by a subset of accounts assigned to a first group (e.g., an engineer group); accesses an entitlement assigned to the subset of accounts according to a policy and defining a first level of permission (e.g., no access)—to access the resource—granted to the subset of accounts; and detects a deviation representing an under-provisioning of permission to access the resource for the subset of accounts.

In one example, the computer system detects the deviation in response to the frequency of attempted accesses within the predefined duration exceeding a threshold quantity (e.g., one attempted access, five attempted accesses).

In another example, the computer system detects the deviation in response to a proportion of accounts, in the subset of accounts, attempting access to the resource during the predefined duration exceeding a threshold proportion (e.g., 25%, 50%).

In this implementation, the computer system can execute the foregoing methods and techniques: to generate a policy including a second entitlement—associated with the subset of accounts (i.e., accounts in the engineer group)—defining a second level of permission (e.g., full access) exceeding the first level of permission; to serve the policy to the operator via the operator portal; and to automatically implement the policy in the computer network in response to operator acceptance of the policy.

The computer system can execute similar methods and techniques: to identify a deviation representing an under-provisioning of permission to access a second resource for a second subset of accounts assigned to a first role (e.g., an executive role); to generate a new policy including an entitlement—associated with the second subset of accounts—defining a succeeding level of permission (e.g., full access) exceeding a preceding level of permission; to serve the new policy to the operator via the operator portal; and to automatically implement the new policy in the computer network in response to operator acceptance of the new policy.

For example, the computer system can: extract a first set of entitlements from the first policy, the first set of entitlements granting permission to a first set of accounts in the computer network to access the first resource according to the first access level, the first set of accounts assigned to a first group in Block S122; access a set of event data representing activity associated with the set of resources during a first time period in Block S130; and detect a first count of access attempts associated with the first resource by a first subset of accounts in the set of accounts based on the set of event data, the first count of access attempts characterized by a second access level.

The computer system can then: detect a deviation between the second access level and the first access level defined in the first set of entitlements in Block S140; and, in response to the deviation and in response to the first count of access attempts exceeding a threshold count of access attempts, generate a second policy representing a second entitlement granting permission to the first set of accounts to access the first resource according to the second access level in Block S150.

More specifically, the computer system can: calculate an average quantity of access attempts by each account in the group of accounts during a target time interval, each access attempt characterized by a second access level exceeding a first (permitted) access level. Then, the computer system can detect the average quantity of access attempts, at the second access level, exceeding a threshold quantity of access attempts at the second access level, indicating that accounts in the group of accounts are requesting access to the first resource at the second access level more frequently than an expected frequency (e.g., more than once in a target time period, more than ten times in a target time period). Thus, based on the average quantity of access attempts exceeding the threshold quantity of access attempts, the computer system can generate a recommendation (e.g., updating the first policy, generating a second policy) to grant the group of accounts permission to access the first resource according to the second access level.

Accordingly, in response to identifying a quantity (or frequency) of access attempts by a set of accounts assigned to a group, characterized by a second access level exceeding a permitted access level (granted by entitlements extracted from policies), exceeding a threshold quantity (or frequency) of access attempts, the computer system can generate a recommendation to grant the second access level to the set of accounts. Therefore, by detecting these deviations in frequency of access attempt(s), the computer system can generate a policy defining an entitlement granting the second access level to the set of accounts; and, in response to operator acceptance of the policy, automatically implement the policy to grant the second access level to the set of accounts.

### 10.3 Role-Based Recommendations

In one implementation, the computer system recommends policy changes (or updates) further based on a role assigned to an identity in Block S162.

More specifically, the computer system: implements methods and techniques as described herein to access a set of access rights granted to a first identity; and generates a first identity container (e.g., account container, role container, group container) representing the first identity. The computer system can then populate the first identity container with a set of attributes representing the first identity including: the set of access rights; and a role assigned to the identity.

In one example, the computer system can: access a first identity data container representing a first identity (e.g., an account); extract a first set of access rights from the first identity container in Block S132; and extract a first role assigned to the first identity from the first identity container in Block S162. Similarly, the computer system can then: access a second identity data container representing a second identity (e.g., a second account); extract a second set of access rights from the second identity container in Block S132; and extract a second role assigned to the second identity from the second identity container in Block S162. Then, the computer system can: detect a first correspondence between the first role assigned to the first identity and a second role assigned to the second identity; and detect a first deviation between the first set of access rights and the second set of access rights. In response to detecting the first deviation, the computer system can then: identify a first subset of access rights present in the first set of access rights and absent from the second set of access rights; and generate a second policy defining a second set of entitlements granting the second identity the first subset of access rights.

Additionally or alternatively, the computer system can generate the second policy defining the second entitlement revoking the first subset of access rights from the first identity.

In one example, a first identity represents a first account assigned to a first group (e.g., an engineering group) and assigned a first role (e.g., manager) in the first group. In this example, during a first time period, the computer system can: implement methods and techniques described herein to extract a first entitlement from a first policy, the first entitlement granting permission to the first account to access a first resource, in a set of resources associated with the computer network, according to a first access level; access a first account container representing the first account, the first account container including attributes of the first account (e.g., historical access attempts); and store the first access level in the first account container in response to extracting the first entitlement. Then, during a second time period, the computer system can: access a set of event data representing activity, by the first account, associated with the set of resources; detect a first access attempt, characterized by a second access level and associated with the first resource, by the first account; generate a record of the first access attempt; and store the record in the first account container.

Then, for a second account assigned to the first group (e.g., the engineering group), and assigned a second role (e.g., project manager) in the first group, the computer system can extract a second entitlement from a second policy, the second entitlement granting permission to the second account to access the first resource according to a second access level; and store the second access level associated with the first resource in the second account container. Then, the computer system can: access a first set of event data representing activity associated with the set of resources during a first time period; and detect a first access attempt associated with the first resource by the first account based on the first set of event data, the first access attempt characterized by the second access level.

The computer system can then: detect a first deviation between the first access level granted to the first account and the second access level associated with the first access attempt. In response to the first deviation, and in response to detecting a correspondence between the first role associated with the first account and the second role associated with the second account, the computer system can: generate a second policy defining a third entitlement granting the first identity the second access level to the resource; and serve the second policy to the operator via the interface.

Accordingly, the computer system can: identify a first access level to a resource granted to a first account (or entity); identify a second access level to the resource granted to a second account (or entity); identify a role assigned to the first account; identify a role assigned to the second account; and, in response to detecting a difference between the first access level and the second access level for the first account and the second account assigned the same role, generate a recommendation (e.g., a second policy) for a second entitlement granting the second account the same access level to the resource as the first account. Therefore, the computer system can identify deviations in access rights across similar roles in the computer network and automatically recommend updating access rights to enforce a policy defining entitlements granting accounts of the same (or similar) role the same (or similar) access rights, such as based on activity by these accounts on resources in the computer network.

### 10.3.1 Hierarchy-Based Recommendations

In a similar implementation, the computer system can: identify a first account associated with a first role (e.g., a temporary account, an intern) in a first group; identify a second account associated with a second role (e.g., a manager) in the first group; and, in response to a first access level, associated with the first account, exceeding a second access level, associated with the second account, generate a recommendation to reduce access rights for the first account.

In particular, the computer system extracts an entitlement from the first policy, the entitlement: granting permission to the first identity in the set of identities to access a second resource, in the set of resources associated with the computer network, according to a third access level, the first identity representing a first account associated with a first group; and granting permission to a second identity in the set of identities to access the second resource according to the third access level, the second identity representing a second account associated with the first group. In this implementation, the computer system can: detect a second deviation between a first role (e.g., manager role) associated with the first account and a second role (e.g., temporary role) associated with the second account; and, based on the second deviation, generate a second policy defining a second entitlement granting permission to the second account to access the second resource according to a first access level falling below the third access level.

Accordingly, the computer system can identify an instance of a first role, such as a first role managed by a second role, exhibiting a higher access level than the second role, and automatically generate a recommendation to reduce access rights for the first role. Therefore, in addition to resolving group-level access levels, the computer system can identify instances in which an entitlement grants a higher access level to a particular role in the group.

### 10.4 Account-Level Recommendations

In yet another implementation, the computer system can, in response to detecting a deviation between activity by an account and activity permitted for the account represented in an entitlement: generate a recommendation (e.g., a recommended policy) to respond to the deviation; and serve the recommendation to an operator via an operator portal.

For example, extracting the first entitlement includes: extracting the first entitlement granting permission to the first identity to access the first resource according to the first access level, the first identity representing a first account associated with a first entity; and generating the second policy includes generating the second policy representing the second entitlement granting permission to the first account to access the first resource according to the second access level.

More specifically, the computer system can: extract a first entitlement from a first policy, the first entitlement granting permission to a first account to access a first resource according to a first access level; access a set of event data representing a set of access attempts between the first account and the first resource; detect a first access attempt in the set of access attempts, the first access attempt characterized by a second access level; and, in response to detecting a deviation between the first access level and the second access level, generating a second policy defining a second entitlement granting the first account the second access level to the first resource.

In one example, the first entitlement grants permission to the first account to access the first resource (e.g., a file) according to a first access level (e.g., reading the file), and the set of event data specifies a first access attempt by the first account, the first access attempt characterized by an attempt to access the first resource at a second access level (e.g., editing the file). Then, in response to detecting the first deviation representing a difference between the first access level and the second access level, the computer system can generate a second policy defining a second entitlement granting permission to the first account to access the first resource according to the second access level.

In another example, the first entitlement grants permission to the first account to access the first resource (e.g., a file) according to a first access level (e.g., reading the file); and a second entitlement grants permission to a first role to access the first resource according to a second access level (e.g., editing the file). In this example, the computer system can: in response to detecting a first access attempt in the set of event data, the first access attempt characterized by the second access level, access an account data container; extract a role associated with the account from the account data container; and, based on the role approximating the first role, generate a second policy representing a third entitlement granting the first account permission to access the first resource according to the second access level.

Accordingly, in response to detecting deviations from activity performed by a particular account to permitted activity defined by entitlements, the computer system can access information about the account to generate specific recommendations for adjustment of access level for the particular account.

### 10.4.1 Account Moving

In one implementation, during a first time period, the computer system can, identify a first entity: represented by a first account assigned to a first role; and associated with a first set of access rights in Block S112. Then, during a second time period succeeding the first time period, the computer system can identify a second account: representing the first entity; assigned to a second role; and associated with a second set of access rights in Block S112. In response to detecting a deviation between the first role and the second role in Block S140, the computer system can: detect the first role assigned to the first entity based on the set of objects; detect absence of the second set of access rights in the first set of access rights; and generate a second policy defining a second entitlement granting the first set of access rights to the second account and revoking the second set of access rights from the second account.

More specifically, in this implementation, the computer system can, during a first time period: extract an entitlement from the first policy, the entitlement granting permission to the first identity in the set of identities to access a resource, in a set of resources, according to a first access level, the first identity representing a first account assigned to a first role. Then, during a second time period succeeding the first time period, the computer system can: detect a second role assigned to the second account; extract a second entitlement from the policy, the second entitlement omitting permission for accounts assigned to the second role to access the resource according to the first access level; and, based on the second entitlement, generate a recommendation to revoke the first access level for the first account.

Accordingly, the computer system can: detect a role change for the first account from the first role during the first time period to the second role during the second time period; detect absence of the first access level, associated with the first role, in an entitlement granting permission to accounts assigned to the second role; and generate a recommendation for removal of the first access level for the first account.

Therefore, the computer system can: reduce risk of unauthorized access to the first resource, such as by a first account previously associated with a high-risk, high-access role; and increase overall security of the computer network by limiting access rights for each account to access rights associated with a current role of the account.

### 10.5 Access Frequency

In one implementation, the computer system can generate a new policy: in response to detecting a first deviation between an attempted access level and a permitted access level in Block S140; and/or in response to detecting a first quantity of access attempts exceeding a threshold quantity of access attempts in Block S140.

More specifically, the computer system can: extract a first entitlement from a first policy, the first entitlement granting a first identity, representing a first account, a first access level to a first resource in the computer network; access a set of event data representing a set of access attempts associated with the first resource by the first account, the set of access attempts characterized by a second access level and a first quantity of access attempts within a first time period. Then, in response to the second access level exceeding the first access level, and in response to the first quantity of access attempts exceeding a threshold quantity of access attempts within the first time period, the computer system can: generate a recommendation to temporarily disable the first account associated with the first identity; and serve the recommendation to the operator via the interface.

For example, the computer system can: access the set of event data representing a set of access attempts associated with the first resource (e.g., a financial statement) by the first identity (e.g., an account), the set of access attempts characterized by a second access level (e.g., downloading) and a first quantity of access attempts (e.g., 100) within a first time period (e.g., one hour); in response to the second access level exceeding a first access level (e.g., reading) permitted by entitlements associated with the first identity and in response to the first quantity of access attempts exceeding a threshold quantity of access attempts (e.g., five) within the first time period, identify the first account as potentially hacked; and, in response to identifying the account as potentially hacked, generating a recommendation to temporarily disable the first account associated with the first identity to prevent further data exfiltration (attempts).

Accordingly, the computer system can generate a recommendation (e.g., updating a first policy, generating a third policy) further based on an access quantity (or frequency) exceeding a threshold access quantity.

Therefore, the computer system can: identify an identity as potentially hacked (e.g., based on detecting impersonation of an account in the computer network by a malicious actor), such as in response to the identity (e.g., an account) attempting to access a resource at an access level exceeding a permitted access level and at a frequency exceeding a permitted (or threshold) frequency; and recommend to temporarily disable the account in response to identifying the account as potentially hacked.

### 11. Iterative Recommendations

The computer system can repeat the foregoing methods and techniques for additional time intervals: to detect updated accounts (roles, and/or groups) affiliated with the computer network during the additional time intervals; to detect new activity by these accounts during the additional time intervals; to detect deviations between this new activity and permitted activity represented by entitlements associated with these accounts; to generate recommended policies based on these deviations and rules generated responsive to feedback from the operator; to serve these recommended policies to the operator; and to automatically implement these recommended policies in the computer network.

### 12. Posture

Generally, the computer system can: identify a set of access rights granted to an identity affiliated with the computer network in Block S164; and derive a posture (e.g., a posture level, a posture score) for the identity based on the set of access rights in Block S160. The posture characterizes a risk level (or score) posed to the computer network and attributed to the identity.

More specifically, the computer system can: access a first set of objects generated by a source and representing a set of identities associated with a computer network; and detect the set of identities based on the first set of objects. The computer system can then: access a first policy associated with the computer network; and extract a first entitlement from the first policy, the first entitlement granting permission to a first identity in the set of identities to access a first resource, in a set of resources associated with the computer network, according to a first access level. Then, in response to extracting the first entitlement, the computer system: calculates a first posture score for the first identity based on the first access level and a first sensitivity level associated with the first resource; and, in response the first posture score exceeding a threshold posture score, generates a second policy representing a second entitlement granting the first identity a second access level to the first resource, the second access level falling below the first access level.

In one variation, the computer system: extracts a third entitlement from the first policy, the third entitlement granting a second identity a third access level to the first resource; calculates a posture score for the second identity based on the third access level and a sensitivity level for data associated with the first resource; and, in response to the first risk score exceeding a threshold risk score, generates a third policy representing a fourth entitlement granting the second identity a fourth access level to the first resource, the fourth access level falling below the third access level.

In this variation, the computer system calculates a posture score for an identity based on a set of access rights granted to the identity by an entitlement (extracted from a policy) and a sensitivity level of data that the identity is permitted to access by those access rights. Then, in response to the posture score exceeding a threshold posture score (e.g., “critical” posture), the computer system can generate a second policy defining a second entitlement granting the identity a second set of access rights, the second entitlement representing a reduction in access rights. For example, a threshold posture score can represent an average provisioning of access rights granted by entitlements associated with policies of the computer network.

In another implementation, the computer system executes the foregoing methods and techniques: to identify a set of identities in a computer network; to identify a set of entitlements granting permission to access resources in a set of resources in the computer network; and to map the set of entitlements to the set of identities.

In this implementation, the computer system identifies a set of access rights assigned to each identity in the set of identities based on the set of entitlements.

For example, the computer system can: access a set of objects generated by a set of sources and representing the set of identities; and identify the set of identities and a set of entitlements based on the set of objects. The set of entitlements can include: a first subset of entitlements associated with a first identity (e.g., a first account for a first application) in the set of identities; and a second subset of entitlements associated with a second identity (e.g., a second account for a second application) in the set of identities.

In this example, the computer system can: detect that the first identity and the second identity correspond to a first entity (e.g., a first employee) in a set of entities affiliated with a computer network; and identify a first set of access rights assigned to the first entity based on the first subset of entitlements and the second subset of entitlements.

More specifically, the computer system can: identify a first subset of access rights assigned to the first identity based on the first subset of entitlements; identify a second subset of access rights assigned to the second identity based on the second subset of entitlements; and, in response to detecting that the first identity and the second identity correspond to the first entity, aggregate the first subset of access rights and the second subset of access rights into the first set of access rights.

In another implementation, the computer system calculates a first posture score for the first entity based on the first set of access rights.

In one example, the computer system calculates the first posture score based on a quantity of access rights in the first set of access rights, a quantity of identities associated with the first entity, and/or a quantity of entitlements associated with the first entity.

Additionally or alternatively, the computer system calculates the first posture score based on an access level (e.g., read-only access, read-write access, administrator access) for each access right in the first set of access rights.

For each entity in the set of entities, the computer system repeats the foregoing methods and techniques to calculate a posture score, in a set of posture scores, for the entity based on a set of access rights assigned to the entity.

In another implementation, the computer system: generates a visualization selectively indicating the set of entities and the set of posture scores; and serves the visualization to an operator via an operator interface.

Therefore, the computer system can: characterize levels of risk posed to the computer network by the set of entities based on access rights assigned to these entities; and notify the operator of these levels of risk in order to enable the operator to prioritize and execute actions according to risk.

### 12.1 Criticality

In one implementation, the computer system: assigns a criticality level to an entity based on a role assigned to the entity in Block S166; and calculates a posture score for the entity based on the criticality level in Block S160.

For example, the computer system can: access a first entity container for the first entity, the first entity container including a first attribute representing a manager role assigned to the first entity; assign the first criticality level (e.g., medium) to the first entity based on the manager role; and calculate the first posture score for the first entity based on the first set of access rights and the first criticality level.

More specifically, the computer system can access a set of weights associated with a set of criticality levels, the set of weights including: a first weight (e.g., “1.5”) associated with a “critical” criticality level; a second weight (e.g, “1.2”) associated with a “high” criticality level; a third weight (e.g., “1”) associated with a “medium” criticality level; and a fourth weight (e.g., “0.5”) associated with a “low” criticality level.

In this example, the computer system can calculate the first posture score for the first entity based on the first set of access rights and the third weight.

In another implementation, the computer system executes similar methods and techniques: to assign a criticality level to an entity based on a group in which the entity is assigned; and calculate a posture score for the entity based on the criticality level.

### 12.2 Privileged Access

Additionally or alternatively, the computer system can: identify presence (or absence) of privileged access assigned to an entity; and calculate a posture score for the entity based on presence of privileged access assigned to the entity.

For example, the computer system can: access the first entity container for the first entity, the first entity container including a second attribute representing privileged access to sensitive data (e.g., financial data, medical data); assign a fifth weight (e.g., “1.4”) to the first entity in response to detecting the second attribute; and calculate the first posture score for the first entity based on the first set of access rights and the fourth weight.

### 12.3 Configuration

In another implementation, the computer system: accesses a configuration (e.g., a security configuration) associated with an entity (or an identity) in Block S164; and calculates a posture score for the entity based on the configuration in Block S160.

More specifically, the computer system can calculate the posture score for each identity in the set of identities includes calculating the risk score further based on a set of configurations associated with each account, in a set of accounts, associated with the identity.

In one example, the computer system: accesses a first configuration for a first identity associated with a first application; in response to absence of multi-factor authentication enforced for the first identity in the first configuration, assigns a sixth weight (e.g., “1.3”) to a first entity associated with the first identity; and calculates a first posture score for the first entity based on a first set of access rights assigned to the first entity and the sixth weight.

The computer system can execute similar methods and techniques to calculate a posture score for an entity based on other elements of a configuration, such as session controls (e.g., sign-in frequency, location restrictions, device restrictions, forced re-authentication), password settings (e.g., password strength, date of last password change, password complexity, history depth, minimum length, required characters), etc.

### 12.4 Group Posture

In one implementation, the computer system executes similar methods and techniques to derive a posture score for a group (or team, organization, company, etc.) including a subset of entities in Block S160.

For example, for each entity in the subset of entities the computer system can execute the foregoing methods and techniques to calculate a posture score—in a set of posture scores—based on a set of access rights assigned to the entity, a criticality level assigned to the entity, presence of privileged access assigned to the entity, and/or a configuration associated with the entity.

In this example, the computer system can aggregate the set of posture scores for the subset of entities as a group posture score characterizing risk level to the computer network and attributed to the group.

### 13. Posture-Based Recommendations

Generally, in response to calculating a posture score for an entity, the computer system can: generate a notification indicating a recommended action based on the posture score in Block S150; and serve the notification to the operator via the operator interface in Block S152.

In one implementation, the computer system executes the foregoing methods and techniques: to assign a first criticality level to the first entity based on a first role (e.g., a manager role) assigned to the first entity; and to calculate a first posture score for the first entity based on a first set of access rights assigned to the first entity and the first criticality level.

In response to the first posture score exceeding a threshold posture score, the computer system: selects a first subset of access rights associated with the first role; identifies a second subset of access rights—absent from the first subset of access rights—in the first set of access rights; generates a notification recommending removal of the second subset of access rights from the first set of access rights; and serves the notification to the operator via the operator interface.

Therefore, by generating the notification recommending removal of the second subset of access rights—absent from the first set of access rights associated with the first role assigned to the first entity—from the first set of access rights assigned to the first entity, the computer system enables the operator to selectively remove the second subset of access rights from the first set of access rights in order: to correct over-provisioning of (or “right-size”) access assigned to the first entity; to ensure that the first entity is assigned access to resources in accordance with the first role; and to reduce risk in the computer network.

### 13.1 Posture Calculation+Recommendations

In one implementation, the computer system can implement methods and techniques to: extract a first entitlement from a first policy, the first entitlement granting permission to a first identity in the set of identities to access a first resource according to a third access level in Block S122; access a first role associated with the first identity in Block S162; assign a first criticality level to the first identity based on the first role in Block S66; calculate a first posture score for the first identity based on the criticality level and the third access level; and, in response to the first posture score exceeding a threshold score, generate a second policy defining a second entitlement granting permission to the first identity to access the first resource according to a second access level, the second access level falling below the first access level.

More specifically, the computer system: identifies a first access level, granted to a first identity by a first entitlement, for a first resource in Block S164; identifies a first role (e.g., a manager) represented by the first identity; assigns a first criticality level (e.g., “6”) to the first identity based on the first role; calculates a first posture score, representing a risk level (or score) posed to the computer network and attributed to the identity, based on the first criticality level, a first sensitivity level for the first resource, and the first access level; and, in response to the first posture score exceeding a threshold posture score, generates a second policy representing a second entitlement granting permission to the first identity to access the first resource according to a second access level, the second access level falling below the first access level.

In another implementation, the computer system: extracts the first entitlement from the first policy by extracting the first entitlement granting permission to the first identity in the set of identities to access a first resource according to a first access level, the first identity representing a first account associated with a first group; extracts a second entitlement from the first policy, the second entitlement permission to a second identity in the set of identities to access the first resource according to a second access level, the second identity representing a second account associated with the first group; calculates a second posture score for the second identity based on the first sensitivity level associated with the first resource, the second access level, and a criticality score associated with the first group; and, in response to the second posture score exceeding the first posture score associated with the first account, generates a second policy representing a second entitlement granting the second identity the second access level to the first resource.

Accordingly, the computer system can generate recommendations for updating policies (e.g., generating a second policy) based on the posture score calculated for a first identity based on access levels associated with the identity, data sensitivity, criticality, and/or group membership.

Therefore, the computer system enables the operator to selectively remove access rights for an identity in order: to correct over-provisioning of (or “right-size”) access assigned to the first identity; to ensure that the first identity is assigned access to resources in accordance with the first role; and to reduce risk in the computer network.

### 13.1 Iterative Posture-Based Recommendations

The computer system can implement methods and techniques as described herein to, during a target time period: ingest a set of policies defining a set of entitlements granting a set of access rights to each identity in the set of identities; calculate a posture score for each identity in the set of identities; identify a subset of identities exhibiting a posture score exceeding a threshold posture score; and generate a recommendation to remove a subset of access rights for the subset of identities.

More specifically, the computer system can: access a first policy associated with the computer network; extract a first set of entitlements from the first policy, the first set of entitlements granting permission to a first set of identities to access a first resource, in a set of resources associated with the computer network, according to a first set of access levels. Then, in response to extracting the first set of entitlements, the computer system can: calculate a posture score for each identity in the set of identities based on a first access level, in the first set of access levels, associated with the identity; and, in response to a first posture score associated with a first identity in the set of identities exceeding a threshold posture score, generate a second policy representing a second entitlement, excluded from the first set of entitlements, granting the first identity a second access level to the first resource, the second access level falling below the first access level.

In one variation, the computer system can, for each policy in a set of policies associated with the computer network: extract a first set of entitlements granting permission to the first identity to access a first set of resources according to a first set of access levels including a first set of access rights, the set of policies including the first policy; and extract a second set of entitlements granting permission to a second identity in the set of identities to access a second set of resources according to a second set of access levels including a second set of access rights. The computer system can then: calculate a second posture score for the second identity based on the second set of access rights; in response to the second posture score exceeding the first posture score, identify a first subset of access rights in the second set of access rights absent from the first set of access rights; generate a recommendation to remove the first subset of access rights from the second set of access rights; and serve the recommendation to the operator via the interface.

In this variation, the computer system identifies a subset of access rights granted to the second identity and absent from the second of access rights associated with the first identity. Then, based on a second posture score for the second identity exceeding a first posture score for the first identity (e.g., representing increased risk for the second identity), the computer system can revoke this subset of access rights from the second identity to resolve the second posture score to the first posture score. Therefore, in this variation, by detecting and resolving discrepancies between posture scores for identities in the computer network, the computer system can increase overall security posture of the computer network.

In this variation, the computer system can: access a set of event data representing interactions between accounts and resources on the computer network; identify a first resource exhibiting a first quantity of interactions with accounts on the computer network; and, in response to the first quantity of interactions falling below a threshold quantity of interactions, generate a recommendation to remove the first resource from the computer network.

Accordingly, the computer system can: compare posture scores across identities the computer network; and make recommendations for access reduction based on deviations in posture scores for similar identities.

### 14. Peer Comparison

In one variation, for each entity in a subset of entities assigned to a target group (e.g., a group of entities assigned a first role, an engineering work group), the computer system executes the foregoing methods and techniques: to identify a subset of identities (or accounts) associated with the entity in Block S112; to identify a subset of entitlements assigned to the subset of identities in Block S122; and to identify a set of access rights assigned to the entity in Block S164.

Additionally, the computer system can calculate: an average (or median, mode, etc.) quantity of identities associated with an average entity in the target group; an average quantity of entitlements assigned to the average entity; and an average quantity of access rights assigned to the average entity.

In this variation, for each entity in the subset of entities assigned to the target group, the computer system calculates a first difference between a quantity of identities associated with the entity and the average quantity of identities associated with the average entity.

In response to the first difference exceeding a first predefined threshold, the computer system executes the foregoing methods and techniques: to select a first subset of access rights associated with the first target group (e.g., the first role); to identify a second subset of access rights—absent from the first subset of access rights—in a set of access rights assigned to the entity; to generate a notification recommending removal of the second subset of access rights from the set of access rights; and to serve the notification to the operator via the operator interface.

Additionally or alternatively, the computer system can execute similar methods and techniques: to calculate a second difference between a quantity of entitlements assigned to the entity and the average quantity of entitlements assigned to the average entity; and/or to calculate a third difference between a quantity of access rights assigned to the entity and the average quantity of access rights assigned to the average entity.

In response to the second difference exceeding a second predefined threshold and/or in response to the third difference exceeding a third predefined threshold, the computer system can execute the foregoing methods and techniques: to generate the notification recommending removal of the second subset of access rights from the set of access rights; and to serve the notification to the operator via the operator interface.

### 15. State Changes+Monitoring

In one implementation, the computer system can: detect a first state of a computer network at a first time; access a second state of the computer network at a second time; and, in response to detecting a deviation between the first state and the second state, recommend a change in policy.

For example, during a target time period, the computer system detects a configuration of a computer network, the configuration including: a set of accounts based on a set of objects; and an access level, for each account in the set of accounts, for a particular resource on the computer network. The computer system then: accesses event data representing activity by accounts on (or with) resources on the computer network; and aggregates the configuration and event data into a first state of the computer network.

Then, at a second time, following the target time period, the computer system: accesses a second configuration of the computer network including the set of accounts based on the set of objects, and a second access level for the resources on the computer network; accesses event data representing activity by accounts on (or with) resources on the computer network; and aggregates the second configuration and event data into a second state of the computer network. The computer system can then: detect a first deviation between the first configuration and the second configuration; and, in response to detecting the first deviation, generate a second policy based on a first policy related to the first deviation and serving the second policy to the operator via the operator portal.

In one example, the computer system can: access a first state of the computer network including a first account, associated with a first entity exhibiting a first role, the first account exhibiting a first access level for a first resource; access a second state of the computer network including the first account associated with the first entity, the first entity exhibiting a second role; access a second policy defining a second entitlement; detect absence of permission, in the second entitlement, for the second role to access the first resource at the first access level; and generate a recommendation to remove the first access level to the first resource for the first account based on the first identity exhibiting a second role distinct from the first role.

Accordingly, in response to detecting a role change from a first role (e.g., legal assistant) to a second role (e.g., an accounting assistant) for an identity (or entity), the computer system can recommend removal of access rights associated with the first role, but not the second role.

Therefore the computer system can: actively monitor the computer network for changes (e.g., role changes, state changes) associated with the computer network; and, in response to detecting changes, generate recommendations to adjust (or “right-size”) access rights for identities associated with the computer network.

### 16. Predictive Analysis

In one variation, the computer system can implement methods and techniques described herein to make predictive recommendations about resources (e.g., applications) on a computer network based on a history of access attempts and access levels associated with the history of access attempts.

In one example the computer system can: access event data representing interactions between accounts and resources on the computer network; and, in response to detecting absence of access attempts for a first account for a first resource, generate a recommendation to remove access for the first account to the first resource.

Additionally or alternatively in response to detecting absence of access attempts for each account for a first resource, the computer system can generate a recommendation to remove the first resource from the computer network.

In a similar variation, the computer system can: access event data representing interactions between identities (e.g., accounts) and resources (e.g., an application) on the computer network; identify a first pattern of interactions, such as an increase in access during a first time period and an absence of access during a second time period; and generate a rule permitting absence of access for the computer system. Additionally or alternatively, the computer system can, in response to identifying a first pattern of interactions, such as an increase in access during a first time period and an absence of access during a second time period, generate a recommendation to temporarily disable the resource during the second time period.

Therefore, by identifying absence of historical accesses to a first resource by a first account at a first access level and generating a recommendation to remove (or temporarily disable) the first resource and/or remove the first access level for the first account, the computer system can: reduce organization spending on operating resources during a period of non-use of the resource; reduce risk of unauthorized access to the first resource (e.g., based on impersonation of an account in the computer network by a malicious actor), such as by decreasing a likelihood of unauthorized access going unnoticed due to lack of access to the first resource by the account; and increase overall security posture of the computer network.

### 16.1 Predictive Policy Generation

In yet another variation, the computer system can detect a second (e.g., a new) resource on the computer network; detect an absence of policy for the resource; identify a resource type for the second resource; identify a third resource of the resource type on the computer network; access a set of policies for the third resource; and generate a policy (or a set of policies) for the second resource based on the set of policies for the third resource.

Therefore, the computer system can leverage policies for resources of a particular resource type to generate similar policies for a second resource of the particular resource type.

### 17. Conclusion

The systems and methods described herein can be embodied and/or implemented at least in part as a machine configured to receive a computer-readable medium storing computer-readable instructions. The instructions can be executed by computer-executable components integrated with the application, applet, host, server, network, website, communication service, communication interface, hardware/firmware/software elements of a user computer or mobile device, wristband, smartphone, or any suitable combination thereof. Other systems and methods of the embodiment can be embodied and/or implemented at least in part as a machine configured to receive a computer-readable medium storing computer-readable instructions. The instructions can be executed by computer-executable components integrated with apparatuses and networks of the type described above. The computer-readable medium can be stored on any suitable computer readable media such as RAMs, ROMs, flash memory, EEPROMs, optical devices (CD or DVD), hard drives, floppy drives, or any suitable device. The computer-executable component can be a processor, but any suitable dedicated hardware device can (alternatively or additionally) execute the instructions.

As a person skilled in the art will recognize from the previous detailed description and from the figures and claims, modifications and changes can be made to the embodiments of the invention without departing from the scope of this invention as defined in the following claims.

I claim:

1. A method comprising:
accessing a first set of objects generated by a source and representing a set of identities associated with a computer network;
detecting the set of identities based on the first set of objects;
accessing a first policy associated with the computer network;
extracting a first entitlement from the first policy, the first entitlement granting permission to a first identity in the set of identities to access a first resource, in a set of resources associated with the computer network, according to a first access level;
accessing a first set of event data representing activity associated with the set of resources during a first time period;
detecting a first access attempt associated with the first resource by the first identity based on the first set of event data, the first access attempt characterized by a second access level;
detecting a deviation between the second access level and the first access level defined in the first entitlement;
generating a second policy representing a second entitlement granting permission to the first identity to access the first resource according to the second access level in response to detecting the deviation; and
serving the second policy to an operator via an interface.

2. The method of claim 1:
wherein extracting the first entitlement comprises extracting the first entitlement granting permission to the first identity to access the first resource according to the first access level, the first identity representing a first account associated with a first entity; and
wherein generating the second policy comprises generating the second policy representing the second entitlement granting permission to the first account to access the first resource according to the second access level.

3. The method of claim 1, further comprising:
extracting a third entitlement from the first policy, the third entitlement granting permission to the first identity to access a second resource in the set of resources according to a third access level; and
wherein generating the second policy comprises generating the second policy omitting the third entitlement in response to detecting absence of an event, representing an access attempt associated with the second resource by the first identity, in the first set of event data.

4. The method of claim 1, further comprising:
extracting a first set of entitlements from the first policy, the first set of entitlements granting permission to a first set of accounts in the computer network to access the first resource according to the first access level, the first set of accounts assigned to a first group;
accessing a second set of event data representing activity associated with the set of resources during a second time period;
detecting a first count of access attempts associated with the first resource by a first subset of accounts in the first set of accounts based on the second set of event data, the first count of access attempts characterized by a third access level;
detecting a second deviation between the third access level and the first access level defined in the first set of entitlements;
in response to the second deviation and in response to the first count of access attempts exceeding a threshold count of access attempts, generating a third policy representing a third entitlement granting permission to the first set of accounts to access the first resource according to the third access level; and
serving the third policy to the operator via the interface.

5. The method of claim 1, further comprising:
extracting a third entitlement from the first policy, the third entitlement granting permission to a second identity, in the set of identities and representing a first account, to access the first resource according to a third access level;
detecting a set of access attempts associated with the first resource by the second identity based on the first set of event data, the set of access attempts characterized by:
a fourth access level; and
a first quantity of access attempts within the first time period;
generating a recommendation to temporarily disable the first account associated with the second identity in response to detecting:
the fourth access level exceeding the third access level; and
the first quantity of access attempts exceeding a threshold quantity of access attempts; and
serving the recommendation to the operator via the interface.

6. The method of claim 1, further comprising:
extracting a third entitlement from the first policy, the third entitlement granting permission to a second identity in the set of identities to access the first resource according to a third access level;
detecting a first role assigned to the second identity;
assigning a first criticality level to the second identity based on the first role;
calculating a first posture score for the second identity based on:
the third access level;
the first criticality level; and
a sensitivity level associated with the first resource;
in response to the first posture score exceeding a threshold score, generating a third policy representing a fourth entitlement granting permission to the second identity to access the first resource according to a fourth access level falling below the third access level; and
serving the third policy to the operator via the interface.

7. The method of claim 1, wherein extracting the first entitlement from the first policy comprises:
detecting a first set of language signals in the first policy;
accessing a model that correlates language signals with entitlements; and
extracting the first entitlement from the first policy based on the model and the first set of language signals.

8. The method of claim 1, further comprising:
generating a first identity container representing the first identity,
populating the first identity container with a set of attributes of the first identity based on the first set of objects, the set of attributes comprising:
a first role assigned to the first identity; and
a first group assigned to the first identity;
in response to extracting the first entitlement from the first policy, storing the first access level granted to the first identity by the first entitlement in the first identity container;
based on the first set of event data, generating a record representing the first access attempt associated with the first resource; and
storing the record in the first identity container.

9. The method of claim 8, further comprising:
extracting a third entitlement from a third policy, the third entitlement granting permission to the first identity to access a second resource, in the set of resources associated with the computer network, according to a third access level, the first identity representing a first account assigned to the first group;
extracting a fourth entitlement from the third policy, the fourth entitlement granting permission to a second identity, in the set of identities, to access the second resource according to a fourth access level, the second identity representing a second account assigned to the first group;
accessing a second identity container representing the second identity;
in response to identifying the first role in the second identity container and in response to the third access level exceeding the fourth access level, generating a third policy defining a fifth entitlement granting permission to the first identity to access the second resource according to a fourth access level; and
serving the third policy to the operator via the interface.

10. The method of claim 1, further comprising:
extracting a third entitlement from the first policy, the third entitlement:
granting permission to the first identity in the set of identities to access a second resource, in the set of resources associated with the computer network, according to a third access level, the first identity representing a first account associated with a first group; and
granting permission to a second identity in the set of identities to access the second resource, in the set of resources associated with the computer network, according to the third access level, the second identity representing a second account associated with the first group;
in response to detecting a manager role assigned to the first account and in response to detecting a temporary role assigned to the second account, generating a third policy representing a fourth entitlement granting the second identity a fourth access level to the second resource, the fourth access level falling below the third access level; and
serving the third policy to the operator via the interface.

11. The method of claim 1, further comprising:
extracting a third entitlement from the first policy, the third entitlement granting permission to a second identity in the set of identities to access the first resource, in the set of resources associated with the computer network, according to a third access level;
calculating a first posture score for the second identity based on:
the third access level; and
a sensitivity level for data associated with the first resource;
in response to the first posture score exceeding a threshold posture score, generating a third policy representing a fourth entitlement granting the second identity a fourth access level to the first resource, the fourth access level falling below the third access level; and
serving the third policy to the operator via the interface.

12. The method of claim 1, further comprising:
during a first time period:
extracting a third entitlement from the first policy, the third entitlement granting permission to the first identity in the set of identities to access a second resource according to a third access level, the first identity representing a first account assigned a first role; and
during a second time period succeeding the first time period:
detecting assignment of a second role to the first identity;
accessing a third policy defining a subset of identities granted permission to access the second resource, the subset of identities comprising the first role;
in response to detecting absence of the second role in the subset of identities, generating a recommendation to revoke the third entitlement from the first identity; and
serving the recommendation to the operator via the operator portal.

13. The method of claim 1, further comprising:
during a second time period:
detecting a second resource, in the set of resources and characterized by a first resource type, on the computer network;
accessing a second set of event data representing activity associated with the set of resources during the second time period; and
detecting a second set of access attempts to the second resource by accounts on the computer network based on the second set of event data; and
during a third time period succeeding the second time period:
detecting a third resource in the set of resources and characterized by the first resource type;
accessing a third set of event data representing a third set of access attempts to the third resource by accounts on the computer network;
accessing a fourth set of event data representing a fourth set of access attempts to the second resource by accounts on the computer network;
in response to the third set of access attempts exceeding a first threshold quantity of access attempts and in response to the fourth set of access attempts falling below a second threshold quantity of access attempts, generating a recommendation to remove the second resource from the computer network; and
serving the recommendation to the operator via the interface.

14. The method of claim 13, wherein accessing the fourth set of event data representing the fourth set of access attempts comprises accessing the fourth set of event data representing an absence of access attempts.

15. A method comprising:
accessing a first set of objects generated by a source and representing a set of identities associated with a computer network;
detecting the set of identities based on the first set of objects;
accessing a first policy associated with the computer network;
extracting a first entitlement from the first policy, the first entitlement granting permission to a first identity in the set of identities to access a first resource, in a set of resources associated with the computer network, according to a first access level;
calculating a first posture score for the first identity based on the first access level and a first sensitivity level associated with the first resource;
in response the first posture score exceeding a threshold posture score, generating a second policy representing a second entitlement granting permission to the first identity to access the first resource according to a second access level falling below the first access level; and
serving the second policy to an operator via an interface.

16. The method of claim 15:
wherein extracting the first entitlement from the first policy comprises extracting the first entitlement granting permission to the first identity in the set of identities, the first identity representing a first account associated with a first group; and
further comprising accessing a first criticality level associated with the first group; and
wherein calculating the first posture score for the first identity comprises calculating the first posture score for the first identity further based on the first criticality level.

17. The method of claim 15:
further comprising, for each policy in a set of policies:
extracting a first set of entitlements representing a first set of access rights granting permission to the first identity to access a first set of resources according to a first set of access levels, the set of policies comprising the first policy; and
extracting a second set of entitlements representing a second set of access rights granting permission to a second identity in the set of identities to access a second set of resources according to a second set of access levels;
wherein calculating the first posture score comprises calculating the first posture score further based on the first set of access rights; and
further comprising:
calculating a second posture score for the second identity based on the second set of access rights;
in response to the second posture score exceeding the first posture score, identifying a first subset of access rights, in the second set of access rights, absent from the first set of access rights;
generating a recommendation to remove the first subset of access rights from the second set of access rights; and
serving the recommendation to the operator via the interface.

18. A method comprising:
accessing a first set of objects generated by a source and representing a set of accounts associated with a computer network;
detecting the set of accounts based on the first set of objects;
accessing a first policy associated with the computer network;
extracting a first entitlement from the first policy, the first entitlement granting permission to a first account in the set of accounts to access a first resource, in a set of resources associated with the computer network, according to a first access level;
accessing a first set of event data representing activity associated with the set of resources during a first time period;
detecting a first access attempt associated with the first resource by the first account based on the first set of event data, the first access attempt characterized by a second access level falling below the first access level defined in the first entitlement;
in response to detecting the first access attempt characterized by the second access level exceeding the first access level, generating a second policy omitting the first entitlement and representing a second entitlement granting permission to the first account to access the first resource according to the second access level; and
serving the second policy to an operator via an interface.

19. The method of claim 18:
wherein extracting the first entitlement from the first policy comprises extracting a first set of entitlements comprising the first entitlement from the first policy, the first set of entitlements representing a first set of access rights granting permission to the first account to access a first subset of resources in the set of resources;
further comprising calculating a first posture score for the first account based on the first set of access rights; and
wherein generating the second policy comprises generating the second policy omitting the first entitlement and representing a second entitlement granting permission to the first account to access the first resource according to the second access level in response to:
detecting the first access attempt characterized by the second access level falling below the first access level; and
the first posture score exceeding the posture score threshold.

20. The method of claim 18:
wherein accessing the first set of event data comprises accessing the first set of event data representing a set of access attempts associated with the first resource by the first account; and
wherein generating the second policy comprises generating the second policy omitting the first entitlement and representing a second entitlement granting permission to the first account to access the first resource according to the second access level in response to:
detecting the first access attempt characterized by the second access level falling below the first access level; and
detecting absence of an access attempt characterized by the first access level in the set of access attempts.
